(19) United States
(12) Patent Application Publication
(10) Pub. No.: US 2010/0164855 A1
(43) Pub. Date: Jul. 1, 2010

(54) Backlight Control Method for Liquid Crystal Panel and Related Liquid Crystal Display

(76) Inventors: Chih-Ping Su, Keelung City (TW); Chi-Chung Tsai, Kinmen County (TW); Chia-Lin Liu, Tai-Chung Hsien (TW); Chi-Neng Mo, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 12/390,504

(22) Filed: Feb. 23, 2009

(30) Foreign Application Priority Data
Dec. 29, 2008 (TW) 097151189

(51) Int. Cl. G09G 3/36; G02F 1/13357

(52) U.S. Cl. 345/102; 349/61

(57) ABSTRACT

A backlight control method for an LCD panel is disclosed, and includes steps of dividing the LCD panel into a plurality of backlight areas; configuring an expanding area and a weighted area for each backlight area of the plurality of backlight areas; and determining backlight intensity of each backlight area according to a weighted average grayscale value calculated with all pixels inside the expanding area and the weighted area, wherein the expanding area is formed by expanding outwardly from each backlight area, and the weighted area is focused on the center of each backlight area and has a range not greater than that of the expanding area.

### BACKGROUND OF THE INVENTION

1. Field of the Invention

The present invention relates to a backlight control method for a liquid crystal panel, and more particularly to a backlight control method for improving light mixing of adjacent backlight area caused by area backlight control.

2. Description of the Prior Art

Transitionally, Cold Cathode Fluorescent Lamps (CCFLs) are used to be light sources of a backlight module in a liquid crystal panel. With the improvement in luminous efficiency and the increasingly lower cost of Light Emitting Diodes (LEDs), there is a tendency to replace the CCFLs with the LEDs as the light sources of the backlight modules.

In addition, due to fast response characteristics of the LEDs, the backlight module of nowadays can further utilize an area backlight control technique to divide the liquid crystal panel into a plurality of backlight area for individually adjusting backlight intensity of each backlight area with image variation of each backlight area, so as to meet the target of reducing power consumption and increasing image contrast.

Generally, the backlight intensity of each backlight area is determined by an average grayscale value of all pixels inside each backlight area. Please refer to FIG. 1, which shows a conventional liquid crystal panel 10 adopting the area backlight control technique. In FIG. 1, backlight areas and pixels are denoted by bold lines and broken lines, respectively. As shown, the liquid crystal panel 10 is divided into M×N backlight areas, and each backlight further includes a plurality of pixels. Taking a backlight area BL1 for example, a numerical value obtained by summing up grayscale values of all pixels inside the backlight area BL1 and divided by a pixel number of the backlight area BL1 is usually used for determining backlight intensity of the backlight area BL1. Other backlight areas can also be determined in like manners, and not narrated again.

However, light beams of the LEDs are not exactly collimated with normal directions, i.e. there exists a Lambertian angle. Thus, when backlight intensities of two adjacent backlight areas differ too much, the backlight area supposed to show black images may have some light leakage existing on its edge caused by backlights of the adjacent backlight area, as shown in FIG. 2.

In short, when grayscale values of the adjacent backlight areas differ too much, the way to determine the backlight intensity of the area backlight control may cause the light leaking on the edges of the displayed area, so as to degrade image qualities.

### SUMMARY OF THE INVENTION

It is therefore an objective of the present invention to provide a backlight control method for a liquid crystal panel and related liquid crystal displays.

According to the present invention, a backlight control method for a liquid crystal panel is disclosed. The backlight control method includes steps of dividing the liquid crystal panel into a plurality of backlight areas to individually control backlight intensity of each backlight area of the plurality of backlight areas, each backlight area of the plurality of backlight areas further comprising a plurality of pixels, configuring an expanding area and a weighted area for each backlight area of the plurality of backlight areas, the expanding area being formed by expanding outwardly from each backlight area, the weighted area being focused on the center of each backlight area and having a range not greater than the expanding area, and determining the backlight intensity of each backlight area according to a weighted average grayscale value calculated with all pixels inside the expanding area and the weighted area.

According to the present invention, a liquid crystal display (LCD) capable of enhancing image quality is disclosed. The LCD includes a liquid crystal panel, a backlight module, a buffering memory and a backlight control module. The backlight module is set on the liquid crystal panel, and is utilized for dividing the liquid crystal panel into a plurality of backlight areas to individually provide backlights for each backlight area of the plurality of backlight areas. Each backlight area of the plurality of backlight areas further comprises a plurality of pixels. The buffering memory is coupled to the liquid crystal panel, and is utilized for temporarily storing grayscale values of all pixels in each backlight area of the plurality of backlight areas. The backlight control module is coupled to the backlight module and the buffering memory, and is utilized for configuring an expanding area and a weighted area for each backlight area of the plurality of backlight areas to determine the backlight intensity of each backlight area according to a weighted average grayscale value calculated with all pixels inside the expanding area and the weighted area. The expanding area is formed by expanding outwardly from each backlight area, and the weighted area is focused on the center of each backlight area and has a range not greater than the expanding area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a conventional liquid crystal panel adopting an area backlight control technique.

FIG. 2 shows light leakage caused by too much grayscale differences between adjacent backlight areas.

FIG. 3 is a schematic diagram of a backlight control process for a liquid crystal panel according to an embodiment of the present invention.

FIG. 4 is a cross-section diagram of a liquid crystal panel.

FIG. 5a to FIG. 5c show embodiments of the backlight control process of FIG. 3, respectively.

FIG. 6 shows an embodiment of the backlight control process of FIG. 3.

FIG. 7 shows an embodiment of the backlight control process of FIG. 3.

FIG. 8 is a schematic diagram of a liquid crystal display (LCD) capable of enhancing image quality according to an embodiment of the present invention.

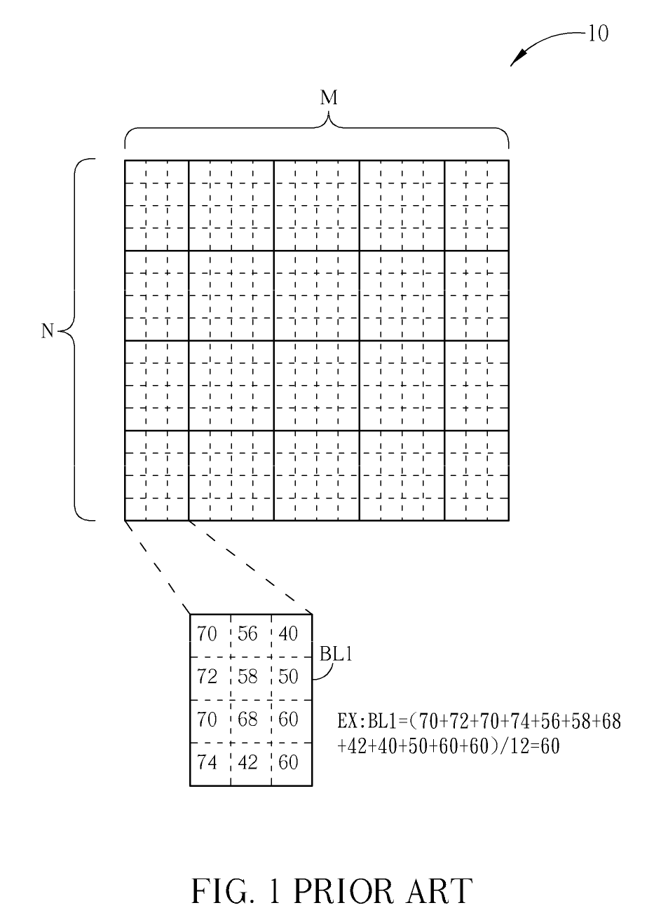

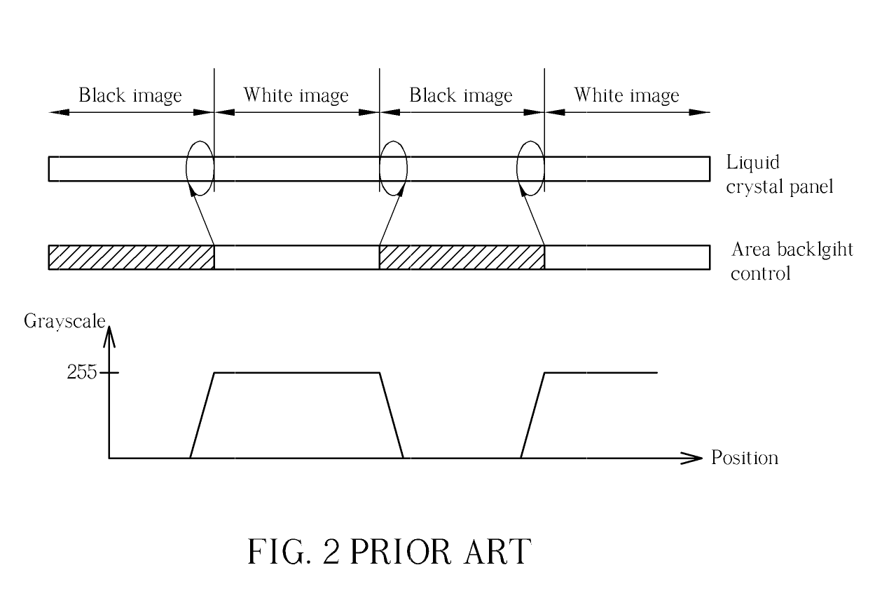

### DETAILED DESCRIPTION

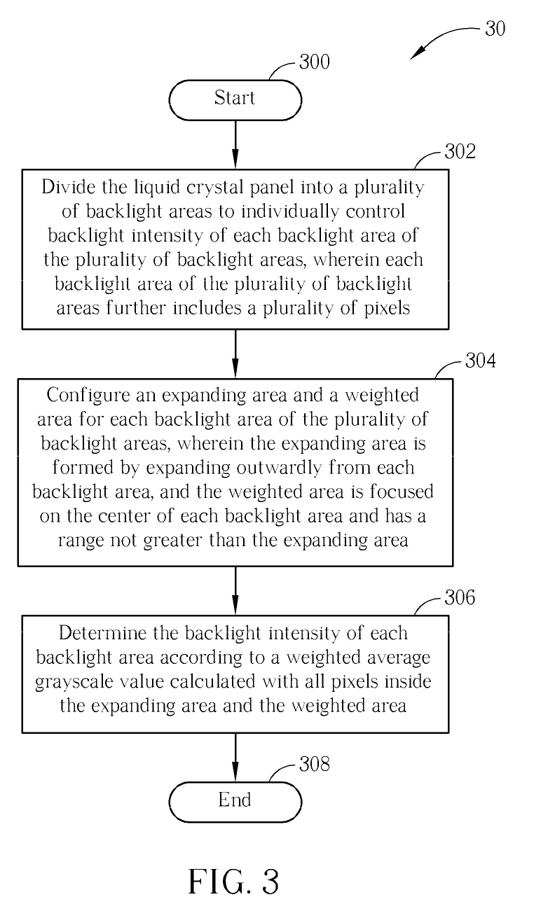

Please refer to FIG. 3. FIG. 3 is a schematic diagram of a backlight control process 30 for a liquid crystal panel according to an embodiment of the present invention. The backlight control process 30 is utilized for improving light mixing of adjacent backlight area caused by area backlight control, and includes the following steps:

Step 300: Start.

Step 302: Divide the liquid crystal panel into a plurality of backlight areas to individually control backlight intensity of each backlight area of the plurality of backlight areas, wherein each backlight area of the plurality of backlight areas further includes a plurality of pixels.

Step 304: Configure an expanding area and a weighted area for each backlight area of the plurality of backlight areas, wherein the expanding area is formed by expanding outwardly from each backlight area, and the weighted area is focused on the center of each backlight area and has a range not greater than the expanding area.

Step 306: Determine the backlight intensity of each backlight area according to a weighted average grayscale value calculated with all pixels inside the expanding area and the weighted area.

Step 308: End.

According to the backlight control process 30, the liquid crystal panel is firstly divided into a plurality of backlight areas for individually controlling the backlight intensity of each backlight area. Then, the expanding area and the weighted area are configured for each backlight area, so that the backlight intensity of each backlight area can be determined according to a weighted average grayscale value calculated with all pixels inside the expanding area and the weighted area. It is note that the expanding area is formed by expanding outwardly from each backlight area, and that the weighted area is focused on the center of each backlight area and has a range not greater than the expanding area.

That is to say, when determining the backlight intensity of the backlight area, the pixel range required to be calculated is enlarged to adjacent backlight areas, and the backlight intensity supposed to be displayed originally is intensified by weighting the center of each backlight area, so as to reduce the light mixing of the adjacent backlight areas.

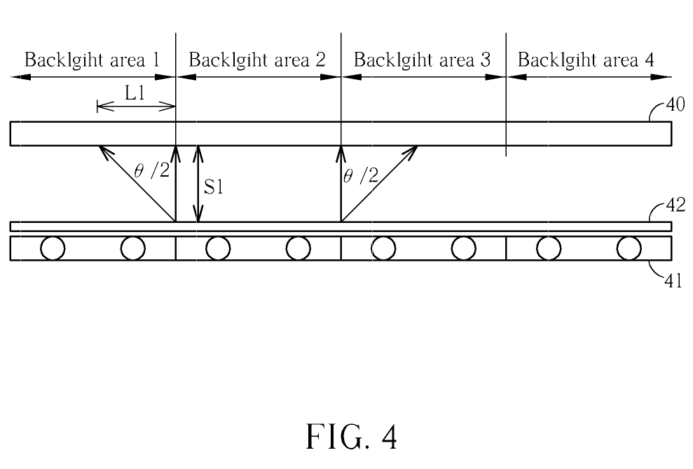

Preferably, backlights of each backlight area are generated by a light emitting device, and the light emitting device is composed of light emitting diodes (LEDs). In such a situation, the backlight control process 30 further includes steps of determining a range of the expanding area according to a Lambertian angle of the light emitting device and spacing between the light emitting device and the liquid crystal panel. Please refer to FIG. 4, which is a cross-section diagram of a liquid crystal panel 40. As shown in FIG. 4, when light beams emit from a backlight module 41 through an optical thin film 42, the light beams of the LEDs are not exactly collimated with normal directions, i.e. there exists a Lambertian angle θ. Thus, in the embodiment of the present invention, a distance L1 required to extend outwardly from the original backlight area can be calculated according to the Lambertian angle θ and spacing S1 between the optical thin film 41 and the liquid crystal panel 42, so that the range of the expanding area can be determined.

In Step 306, the backlight intensity of each backlight area is determined according to the average grayscale values of all pixels inside the expanding area and those inside the weighted area. Thus, if the weighting of the weighted area is set to be 1, the sum of a pixel number of the expanding area and that of the weighted area is preferred to be the power of 2, such that implementation of the division operation can be simplified. In this case, the embodiment of the present invention can take advantage of simple right shift operation to implement the division operation, and thus the backlight intensity of each backlight area can be calculated easily.

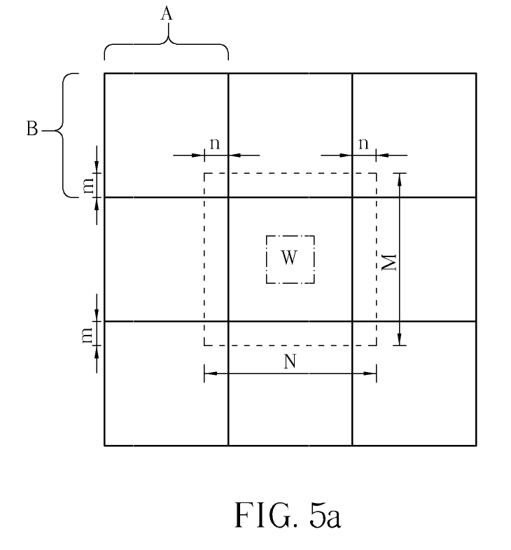

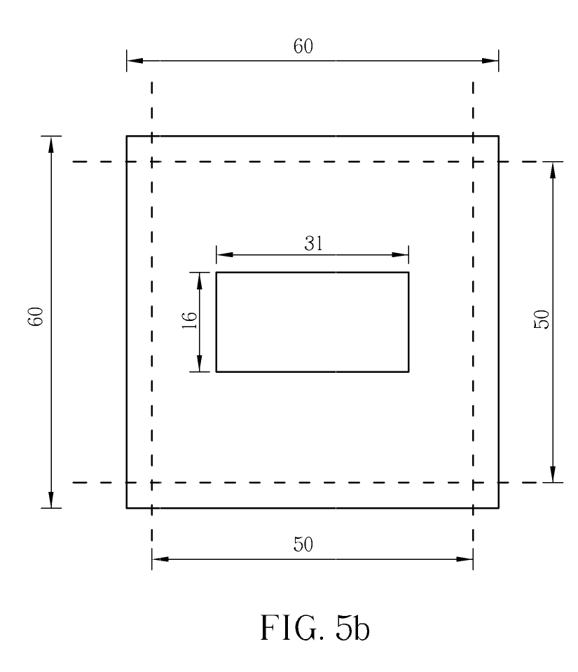

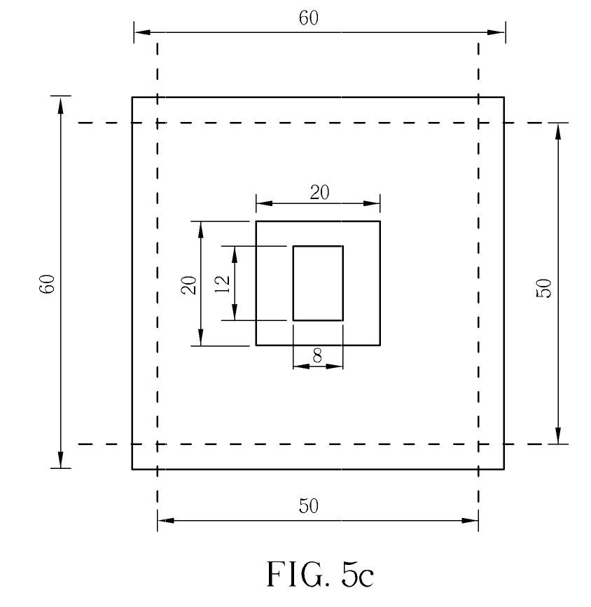

Please refer to FIG. 5a, which shows an embodiment of the backlight control process 30 of the present invention. In FIG. 5a, solid lines denote a range of the original backlight area, broken lines denote a range of the expanding area, and chain-dotted lines denote a range of the weighted area, respectively. Firstly, the range of the expanding area can be determined according to the Lambertian angle of the light emitting device and the spacing between the liquid crystal panel and the light emitting device. As shown in FIG. 5a, assume that the original backlight area includes A×B pixels, by the above calculation, the expanding area can expand m pixels and n pixels outwardly from the backlight area along the horizontal direction and the vertical direction, respectively, and therefore includes N×M pixels. The values of N and M can be given as follows: N=A+2n; M=B+2m. Then, the range of the weighted area can be appropriately adjusted to make the sum of the weighted pixel numbers of the expanding area and that of the weighted area to be the power of 2, so as to simplify implementation of the division operation. It can be given as follows: W=2^{K}−N×M, wherein W denotes the pixel number of the weighted area and K is an positive integer to make 2^{K} large than or equal to N×M.

For example, if the original backlight area includes 50×50 pixels (A=50, B=50), and the expanding area are formed by expanding 5 pixels along the horizontal direction and the vertical direction, respectively (n=5, m=5), the expanding area therefore includes 60×60 pixels (N=60, M=60), i.e. N×M=3600. In this case, the value of K can be set to a minimum value (K=12) such that 2^{K} is large than the pixel number of the expanding area. Thus, the weighted pixel number of the weighted area is equal to 496 pixels (W=2¹²−3600), which can form a square area including 31×16 pixels as shown in FIG. 5b; or can form a square area including 20×20 pixels and a double weighted small area including 8×12 pixels further on its center (20×20+8×12=496) as shown in FIG. 5c.

As a result, by the backlight control process 30 of the present invention, light leakage on the edges of the displayed area can be improved even when the grayscale values of the adjacent backlight areas differ too much, so as to enhance image qualities.

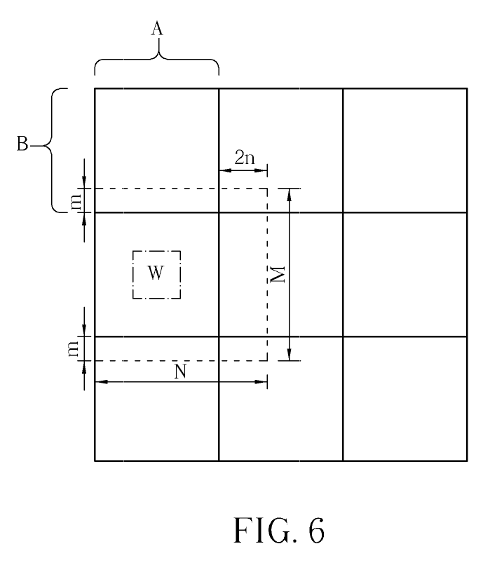

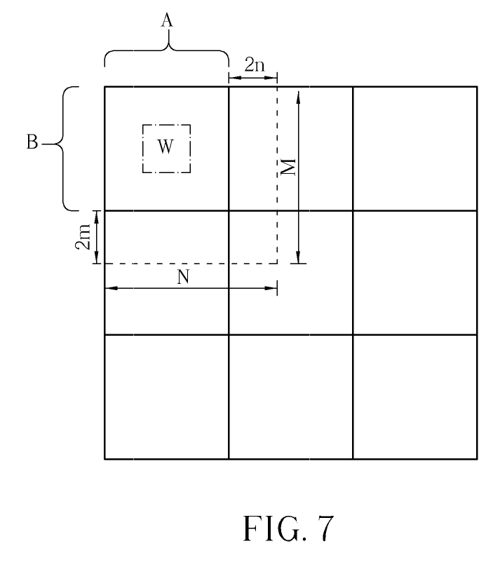

On the other hand, if the backlight area is located at borders or corners of the liquid crystal panel, the expanding area then merely expands toward the center of the liquid crystal panel to make the pixel number being included equal to that of other backlight area as shown in FIG. 6 and FIG. 7. Such variations also belong to the scope of the present invention. Please note that the above embodiments are merely exemplary illustrations but not limitations of the present invention, and that those skilled in the art can certainly make appropriate modifications according to practical demands, such as adjusting the weighting or position of the weighted area, which also belong to the scope of the present invention.

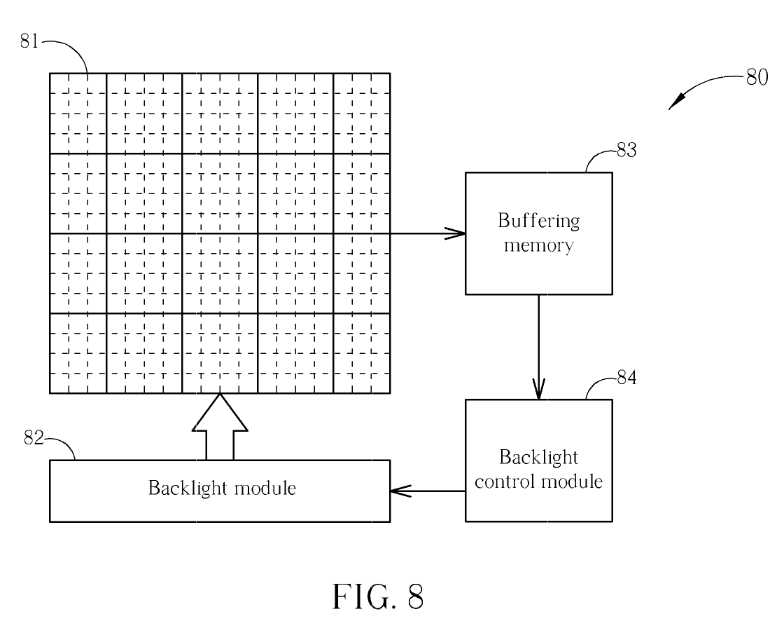

Please further refer to FIG. 8. FIG. 8 is a schematic diagram of a liquid crystal display (LCD) 80 capable of enhancing image quality according to an embodiment of the present invention. The LCD 80 is utilized for realizing the said backlight control process 30, and includes a liquid crystal panel 81, a backlight module 82, a buffering memory 83 and a backlight control module 84. The backlight module 82 is set on the liquid crystal panel 81, and is utilized for dividing the liquid crystal panel 81 into a plurality of backlight areas to individually provide backlights for each backlight area of the plurality of backlight areas. The buffering memory 83 is coupled to the liquid crystal panel 81, and is utilized for temporarily storing grayscale values of all pixels in each backlight area. The backlight control module 84 is coupled to the backlight module 82 and the buffering memory 83, and is utilized for configuring an expanding area and a weighted area for each backlight area to determine the backlight intensity of each backlight area according to a weighted average grayscale value calculated with all pixels inside the expanding area and the weighted area. It is note that the expanding area is formed by expanding outwardly from each backlight area, and that the weighted area is focused on the center of each backlight area and has a range not greater than the expanding area. Detailed operation of the LCD 80 is already illustrated in the above, and thus not described again herein.

As mentioned above, when determining the backlight intensity of the backlight area, the pixel range required to be calculated is enlarged to adjacent backlight areas, and the backlight intensity supposed to be displayed originally is further intensified by weighting the center of each backlight area, so that the backlight intensity may not be over modified due to the grayscale differences between the adjacent backlight areas. As a result, the present invention can improve the light leakage on the edges of the displayed area when the backlight intensities of the adjacent backlight areas differ too much, so as to enhance the image qualities.

Those skilled in the art will readily observe that numerous modifications and alterations of the device and method may be made while retaining the teachings of the invention.

What is claimed is:

1. A backlight control method for a liquid crystal panel, the method comprising:
dividing the liquid crystal panel into a plurality of backlight areas to individually control backlight intensity of each backlight area of the plurality of backlight areas, each backlight area of the plurality of backlight areas further comprising a plurality of pixels;
configuring an expanding area and a weighted area for each backlight area of the plurality of backlight areas, the expanding area being formed by expanding outwardly from each backlight area, the weighted area being focused on the center of each backlight area and having a range not greater than the expanding area; and
determining the backlight intensity of each backlight area according to a weighted average grayscale value calculated with all pixels inside the expanding area and the weighted area.

2. The backlight control method of claim 1, wherein the sum of a weighted pixel number of the expanding area and that of the weighted area is the power of 2.

3. The backlight control method of claim 1, wherein backlights of each backlight area of the plurality of backlight areas are generated by a light emitting device.

4. The backlight control method of claim 3 further comprising:
determining a range of the expanding area according to a Lambertian angle of the light emitting device and spacing between the light emitting device and the liquid crystal panel.

5. The backlight control method of claim 3, wherein the light emitting device is composed of light emitting diodes (LEDs).

6. A liquid crystal display (LCD) capable of enhancing image quality, the LCD device comprising:
a liquid crystal panel;
a backlight module, set on the liquid crystal panel, for dividing the liquid crystal panel into a plurality of backlight areas to individually provide backlights for each backlight area of the plurality of backlight areas, each backlight area of the plurality of backlight areas further comprising a plurality of pixels;
a buffering memory, coupled to the liquid crystal panel, for temporarily storing grayscale values of all pixels in each backlight area of the plurality of backlight areas; and
a backlight control module, coupled to the backlight module and the buffering memory, for configuring an expanding area and a weighted area for each backlight area of the plurality of backlight areas to determine the backlight intensity of each backlight area according to a weighted average grayscale value calculated with all pixels inside the expanding area and the weighted area;
wherein the expanding area is formed by expanding outwardly from each backlight area, and the weighted area is focused on the center of each backlight area and has a range not greater than the expanding area.

7. The LCD of claim 6, wherein the sum of a weighted pixel number of the expanding area and that of the weighted area is the power of 2.

8. The LCD of claim 6, wherein the backlights of each backlight area of the plurality of backlight areas are generated by a light emitting device.

9. The LCD of claim 8, wherein the backlight control module further determines a range of the expanding area according to a Lambertian angle of the light emitting device and spacing between the light emitting device and the liquid crystal panel.

10. The LCD of claim 8, wherein the light emitting device is composed of light emitting diodes (LEDs).
